(19) United States
(12) Patent Application Publication
(10) Pub. No.: US 2010/0314997 A1
(43) Pub. Date: Dec. 16, 2010

(54) PLASMA DISPLAY PANEL

(76) Inventors: Keiji Horikawa, Osaka (JP); Koji Aoto, Hyogo (JP); Kaname Mizokami, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/521,624

(22) PCT Filed: Feb. 10, 2009
(86) PCT No.: PCT/JP2009/000518

§ 371 Date: Jun. 29, 2009

(30) Foreign Application Priority Data
Feb. 13, 2008 (JP) 2008-031358

(51) Int. Cl. H01J 17/49

(52) U.S. Cl. 313/582

(57) ABSTRACT

A plasma display panel is formed of front panel (2) and rear panel (10). Front panel (2) includes glass substrate (3) on which display electrodes (6) are formed, dielectric layer (8) covering display electrodes (6), and protective layer (9) formed on dielectric layer (8). Rear panel (10) confronts front panel (2) to form discharge space (16) therebetween, and includes address electrodes (12) formed along a direction intersecting with display electrodes (6), primary dielectric layer (13) covering address electrodes (12), and barrier ribs (14) formed on primary dielectric layer (13) for partitioning discharge space (16). Protective layer (9) includes a primary film made of metal oxide and formed on dielectric layer (8), and an aggregated particle formed of several crystal particles aggregated together and made of metal oxide and attached to the primary film. A percentage of voids of primary dielectric layer (13) falls within a range from 2% to 20%.

### TECHNICAL FIELD

The present invention relates to plasma display panels to be used in display devices.

### BACKGROUND ART

A plasma display panel (hereinafter referred to simply as a PDP) allows achieving a high definition display and a large-size screen, so that television receivers (TV) with a large screen having as large as 65 inches diagonal length can be commercialized by using the PDP. In recent years, use of the PDP in high-definition TVs, which need more than doubled scanning lines than conventional NTSC method, has progressed and the PDP free from lead (Pb) has been required in order to contribute to environment protection.

The PDP is basically formed of a front panel and a rear panel. The front panel comprises the following structural elements:
a glass substrate made of sodium-borosilicate-based float glass;
display electrodes, formed of striped transparent electrodes and bus electrodes, formed on a principal surface of the glass substrate,
a dielectric layer covering the display electrodes and working as a capacitor; and
a protective layer made of magnesium oxide (MgO) and formed on the dielectric layer.

The rear panel comprises the following structural elements:
a glass substrate;
striped address electrodes formed on a principal surface of the glass substrate,
a primary dielectric layer covering the address electrodes;
barrier ribs formed on the primary dielectric layer; and
phosphor layers formed between the respective barrier ribs and emitting light in red, green, and blue respectively.

The front panel confronts the rear panel such that its electrode-mounted surface faces an electrode-mounted surface of the rear panel, and peripheries of both the panels are sealed in an airtight manner to form a discharge space in between, and the discharge space is partitioned by the barrier ribs. The discharge space is filled with discharge gas of Neon (Ne) and Xenon (Xe) at a pressure ranging from 5.3×104 Pa to 8.0×104 Pa. The PDP allows displaying a color video through this method: Voltages of video signals are selectively applied to the display electrodes for discharging, thereby producing ultra-violet rays, which excite the respective phosphor layers, so that colors in red, green, and blue are emitted, thereby achieving the display of a color video.

The protective layer formed on the dielectric layer of the front panel of the foregoing PDP is expected to carry out the two major functions: (1) protecting the dielectric layer from ion impact caused by the discharge, and (2) emitting primary electrons for generating address discharges. The protection of the dielectric layer from the ion impact plays an important role for preventing a discharge voltage from rising, and the emission of primary electrons for generating the address discharges also plays an important role for eliminating a miss in the address discharges because the miss causes flickers on videos.

To reduce the flickers on videos, the number of primary electrons emitted from the protective layer should be increased. For this purpose, impurities are added to MgO or particles of MgO are formed on the protective layer made of MgO. These instances are disclosed in, e.g. Patent Documents 1, 2, 3.

In recent years, the number of high-definition TV receivers has increased, which requires the PDP to be manufactured at a lower cost, to consume a lower power, and to be a full HD (high-definition, 1920×1080 pixels, and progressive display) with a higher brightness. The characteristics of emitting electrons from the protective layer determine the picture quality, so that it is vital for controlling the electron emission characteristics.

A protective layer added with a mixture of impurities has been tested whether or not this addition can improve the electron-emission characteristics; however, when the characteristics can be improved, electric charges are stored on the surface of the protective layer. If the stored electric charges are used as a memory function, the number of electric charges decreases greatly with time, i.e. an attenuation rate becomes greater. To overcome this attenuation, a measure is needed such as increment in an applied voltage. The protective layer thus should have two contradictory characteristics, i.e. one is a high emission of electrons, and the other one is a smaller attenuation rate for a memory function, namely, a high retention of electric charges.

MgO particles are formed on the protective layer made of MgO for satisfying the foregoing characteristics contradictory to each other. However, when MgO particles are formed on the protective layer made of MgO, the discharge has needle crystals grow around the MgO particles as a core. As a result, the region covered with the needle crystals can be prevented from being dug by sputtering. On the other hand, a region, where no needle crystals grow, of the protective layer proceeds to be dug by sputtering, and the service life of the PDP is thus obliged to be shortened.

Patent Document 1: Unexamined Japanese Patent Application Publication No. 2002-260535

Patent Document 2: Unexamined Japanese Patent Application Publication No. H11-339665

Patent Document 3: Unexamined Japanese Patent Application Publication No. 2006-59779

### DISCLOSURE OF INVENTION

The PDP of the present invention comprises the following structural elements:
a front panel including a substrate on which display electrodes are formed, a dielectric layer covering the display electrodes, and a protective layer formed on the dielectric layer; and
a rear panel opposing to the front panel to form a discharge space therebetween, and including address electrodes formed along the direction intersecting with the display electrodes, a primary dielectric layer covering the address electrodes, and barrier ribs formed on the primary dielectric layer for partitioning the discharge space.
   The protective layer includes a primary film made of metal oxide and formed on the dielectric layer, and an aggregated particle formed of several crystal particles aggregated together and made of metal oxide and attached to the primary film.

The structure discussed above allows providing a PDP that can improve both of the electron emission characteristics and the electric charge retention characteristics of the PDP, so that this PDP can display a quality picture and operate at a lower voltage. On top of that, the structure also prevents the primary film from being dug by sputtering for prolonging the service life of the PDP.

### BRIEF DESCRIPTION OF DRAWINGS

FIG. 1 shows a perspective view illustrating a structure of a PDP in accordance with an embodiment of the present invention.

FIG. 2 shows a sectional view illustrating a structure of a front panel of the PDP.

FIG. 3 shows a sectional view enlarging a protective layer of the PDP.

FIG. 4 shows an enlargement for the description purpose of aggregated particles existing in the protective layer of the PDP.

FIG. 5 shows a relation among the percentage of voids of the primary dielectric layer, the electron emission characteristics, and the sputtering amount (dug depth by sputtering) to the primary film of the PDP.

FIG. 6 shows a relation between a diameter of a crystal particle made of MgO and the electron emission characteristics of the PDP.

FIG. 7 shows a relation between a diameter of a crystal particle and a rate of occurrence of breakage in barrier ribs.

### DESCRIPTION OF REFERENCE MARKS

1 PDP
2 front panel
3 front glass substrate
4 scan electrode
4a, 5a transparent electrode
4b, 5b metal bus electrode
5 sustain electrode
6 display electrode
7 light proof layer
8 dielectric layer
9 protective layer
10 rear panel
11 rear glass substrate
12 address electrode
13 primary dielectric layer
14 barrier rib
15 phosphor layer
16 discharge space
81 first dielectric layer
82 second dielectric layer
91 primary film
92 aggregated particles
92a crystal particle

### BEST MODE FOR CARRYING OUT THE INVENTION

An exemplary embodiment of the present invention is demonstrated hereinafter with reference to the accompanying drawings.

### Exemplary Embodiment

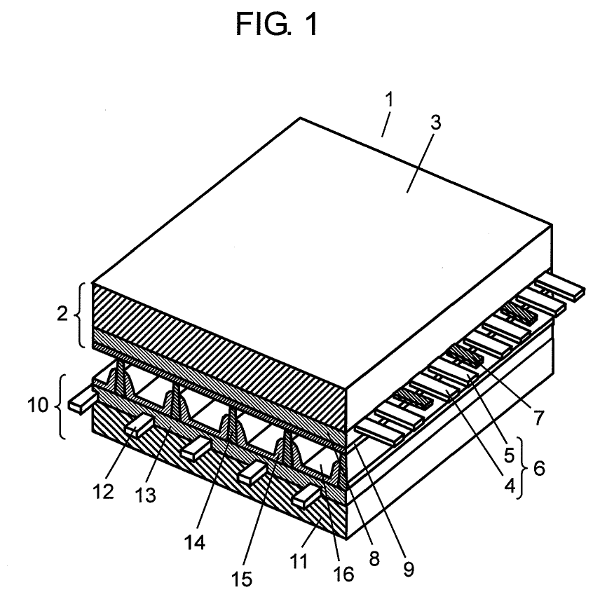

FIG. 1 shows a perspective view illustrating a structure of the PDP in accordance with an the embodiment of the present invention. The PDP is basically structured similarly to a PDP of AC surface discharge type generally used. As shown in FIG. 1, PDP 1 is formed of front panel 2, which includes front glass substrate 3, and rear panel 10, which includes rear glass substrate 11. Front panel 2 and rear panel 10 confront each other and the peripheries thereof are airtightly sealed with sealing agent such as glass frit, thereby forming discharge space 16, which is filled with discharge gas of Ne and Xe at a pressure falling within a range between 5.3×104 Pa and 8.0×104 Pa.

Multiple pairs of belt-like display electrodes 6, each of which is formed of scan electrode 4 and sustain electrode 5, are placed in parallel with multiple lightproof layers 7 on front glass substrate 3 of front panel 2. Dielectric layer 8 working as a capacitor is formed on front glass substrate 3 such that layer 8 can cover display electrodes 6 and lightproof layers 7. On top of that, protective layer 9 made of magnesium oxide (MgO) is formed on the surface of dielectric layer 8.

Multiple belt-like address electrodes 12 are placed in parallel with one another on rear glass substrate 11 of rear panel 10, and they are placed along a direction intersecting at right angles with scan electrodes 4 and sustain electrodes 5 formed on front panel 2. Primary dielectric layer 13 covers those address electrodes 12. Barrier ribs 14 having a given height are formed on primary dielectric layer 13 placed between respective address electrodes 12, and barrier ribs 14 partition discharge space 16. Phosphor layers 15 are applied, in response to respective address electrodes 12, onto grooves formed between each one of barrier ribs 14. Phosphor layers 15 emit light in red, blue, and green with an ultraviolet ray respectively. A discharge cell is formed at a junction point where scan electrode 14, sustain electrode 15 and address electrode 12 intersect with each other. The discharge cells having phosphor layers 15 of red, blue, and green respectively are placed along display electrodes 6, and these cells work as pixels for color display.

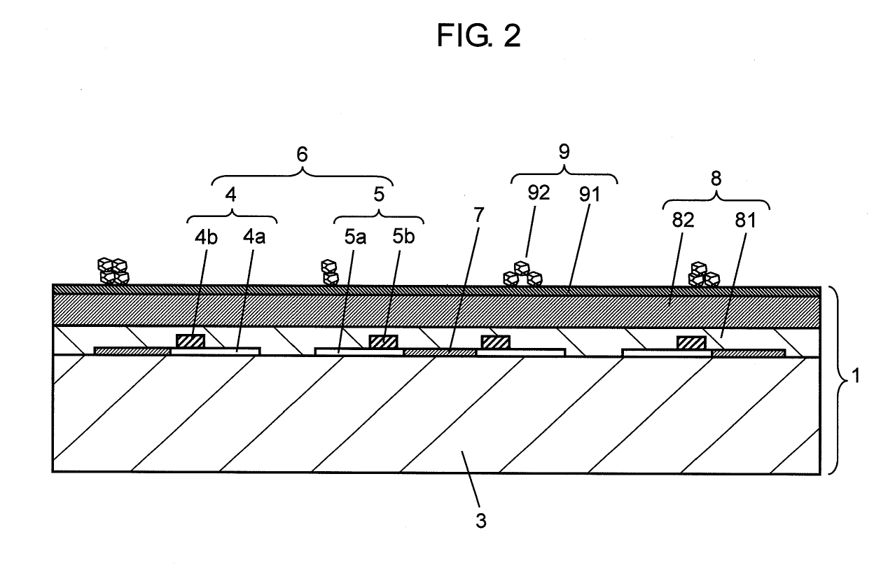

FIG. 2 shows a sectional view illustrating a structure of front panel 2 of the PDP in accordance with this embodiment. FIG. 2 shows front panel 2 upside down from that shown in FIG. 1. As shown in FIG. 2, display electrode 6 formed of scan electrode 4 and sustain electrode 5 is patterned on front glass substrate 3 manufactured by the float method. Lightproof layer 7 is also patterned together with display electrode 6 on substrate 3. Scan electrode 4 and sustain electrode 5 are respectively formed of transparent electrodes 4a, 5a made of indium tin oxide (ITO) or tin oxide (SnO₂), and metal bus electrodes 4b, 5b formed on transparent electrodes 4a, 5a. Metal bus electrodes 4b, 5b give electrical conductivity to transparent electrodes 4a, 5a along the longitudinal direction of electrodes 4a, 5a, and they are made of conductive material of which chief ingredient is silver (Ag).

Dielectric layer 8 is formed of at least two layers, i.e. first dielectric layer 81 that covers transparent electrodes 4a, 5a and metal bus electrodes 4b, 5b and light proof layer 7 formed on front glass substrate 3, and second dielectric layer 82 formed on first dielectric layer 81. On top of that, protective layer 9 is formed on second dielectric layer 82.

Next, a method of manufacturing the PDP is demonstrated hereinafter. First, form scan electrodes 4, sustain electrodes 5, and lightproof layer 7 on front glass substrate 3. Scan electrode 4 and sustain electrode 5 are respectively formed of transparent electrodes 4a, 5a and metal bus electrodes 4b, 5b. These transparent electrodes 4a, 5a, and metal bus electrodes 4b, 5b are patterned with a photo-lithography method. Transparent electrodes 4a, 5a are formed by using a thin-film process, and metal bus electrodes 4b, 5b are made by firing the paste containing silver (Ag) at a given temperature before the paste is hardened. Light proof layer 7 is made by screen-printing the paste containing black pigment, or by forming the black pigment on the entire surface of the glass substrate, and then patterning the pigment with the photolithography method before the paste is fired.

Next, apply dielectric paste onto front glass substrate 3 with a die-coating method such that the paste can cover scan electrodes 4, sustain electrodes 5, and lightproof layer 7, thereby forming a dielectric paste layer (dielectric material layer). Then leave front glass substrate 3, on which dielectric paste is applied, for a given time as it is, so that the surface of the dielectric paste is leveled to be flat. Then fire and harden the dielectric paste layer for forming dielectric layer 8 which covers scan electrodes 4, sustain electrodes 5 and lightproof layer 7. The dielectric paste is a kind of paint containing binder, solvent, and dielectric material such as glass powder.

Next, form primary film 91 made of MgO on dielectric layer 8 by the vacuum deposition method, then form protective layer 9 on primary film 91 through the following process: Multiple aggregated particles 92, each of which is formed of several crystal particles 92a made of metal oxide, i.e. MgO, are attached onto primary film 91 by the screen printing method, thereby dispersing aggregated particles 92 uniformly over the entire face of primary film 91.

The foregoing steps allow forming a predetermined structural elements (scan electrodes 4, sustain electrodes 5, lightproof layer 7, dielectric layer 8 and protective layer 9) on front glass substrate 3, so that front panel 2 is completed.

Rear panel 10 is formed this way: First, form a material layer, which is a structural element of address electrode 12, by screen-printing the paste containing silver (Ag) onto rear glass substrate 11, or by patterning with the photolithography method a metal film which is formed in advance on the entire surface of rear glass substrate 11. Then fire the material layer at a given temperature, thereby forming address electrode 12. Next, form a dielectric paste layer on rear glass substrate 11, on which address electrodes 12 are formed, by applying dielectric paste onto substrate 11 with the die-coating method such that the layer can cover address electrodes 12. Then fire the dielectric paste layer for forming primary dielectric layer 13.

Similar to dielectric layer 8 of front panel 2, the dielectric paste to be used as the material for primary dielectric layer 13 is formed of paint containing dielectric material such as glass powder, binder, and solvent. Adjustment of a content of the binder and others allows controlling the percentage of voids of primary dielectric layer 13 having undergone the firing.

In the experiments for the present invention, adjust the content of the binder, thereby varying the percentage of voids of primary dielectric layer 13 of PDP up to 50% (max). The PDPs thus produced experimentally are tested.

Next, apply the paste containing the material for barrier rib onto primary dielectric layer 13, and pattern the paste into a given shape, thereby forming a barrier-rib layer. Then fire this barrier-rib layer for forming barrier ribs 14. The photolithography method or a sand-blasting method can be used for patterning the paste applied onto primary dielectric layer 13. Next, apply the phosphor paste containing phosphor material onto primary dielectric layer 13 surrounded by barrier ribs 14 adjacent to one another and also onto lateral walls of barrier ribs 14. Then fire the phosphor paste for forming phosphor layer 15. The foregoing steps allow completely forming rear panel 10, including the predetermined structural elements, on rear glass substrate 11.

Front panel 2 and rear panel 10 discussed above are placed confronting each other such that scan electrodes 4 intersect with address electrodes 12 at right angles, and the peripheries of panel 2 and panel 10 are sealed with glass frit to form discharge space 16 therebetween, and space 16 is filled with discharge gas including Ne, Xe. PDP 1 is thus completed.

First dielectric layer 81 and second dielectric layer 82 forming dielectric layer 8 of front panel 2 are detailed hereinafter. The dielectric material of first dielectric layer 81 is formed of the following compositions: bismuth oxide (Bi₂O₃) in 20-40 wt %; at least one composition in 0.5-12 wt % selected from the group consisting of calcium oxide (CaO), strontium oxide (SrO), and barium oxide (BaO); and at least one composition in 0.1-7 wt % selected from the group consisting of molybdenum oxide (MoO₃), tungstic oxide (WO₃), cerium oxide (CeO₂), and manganese dioxide (MnO₂).

At least one composition in 0.1-7 wt % selected from the group consisting of copper oxide (CuO), chromium oxide (Cr₂O₃), cobalt oxide (CO₂O₃), vanadium oxide (V₂O₇), and antimony oxide (Sb₂O₃) can replace the foregoing molybdenum oxide (MoO₃), tungstic oxide (WO₃), and cerium oxide (CeO₂), manganese dioxide (MnO₂).

Other than the foregoing compositions, the following compositions free from lead (Pb) can be contained: zinc oxide (ZnO) in 0-40 wt %; boron oxide (B₂O₃) in 0-35 wt %; silicon dioxide (SiO₂) in 0-15 wt %, and aluminum oxide (Al₂O₃) in 0-10 wt %.

The dielectric material containing the foregoing compositions is grinded by a wet jet mill or a ball mill into powder of which average particle diameter is 0.5 μm-2.5 μm. Next, this dielectric powder in 55-70 wt % and binder component in 30-45 wt % are mixed with a three-roll mill, so that the paste for the first dielectric layer to be used in the die-coating or the printing can be produced.

The binder component is formed of terpinol or butyl carbitol acetate which contains ethyl-cellulose or acrylic resin in 1 wt %-20 wt %. The paste can contain, upon necessity, plasticizer such as dioctyl phthalate, dibutyl phthalate, triphenyl phosphate, tributyl phosphate, and dispersant such as glycerop mono-oleate, sorbitan sesquio-leate, alkyl-allyl based phosphate for improving the printing performance.

Next, the paste for the first dielectric layer discussed above is applied to front glass substrate 3 with the die-coating method or the screen-printing method such that the paste covers display electrodes 6, before the paste is dried. The paste is then fired at 575-590° C. a little bit higher than the softening point of the dielectric material.

Second dielectric layer 82 is detailed hereinafter. The dielectric material of second dielectric layer 82 is formed of the following compositions: bismuth oxide (Bi₂O₃) in 11-20 wt %; at least one composition in 1.6-21 wt % selected from the group consisting of calcium oxide (CaO), strontium oxide (SrO), and barium oxide (BaO); and at least one composition in 0.1-7 wt % selected from the group consisting of molybdenum oxide (MoO₃), tungstic oxide (WO₃), and cerium oxide (CeO₂).

At least one composition in 0.1-7 wt % selected from the group consisting of copper oxide (CuO), chromium oxide (Cr₂O₃), cobalt oxide (Co₂O₃), vanadium oxide (V₂O₇), antimony oxide (Sb₂O₃), and manganese dioxide (MnO₂) can replace the foregoing molybdenum oxide (MoO₃), tungstic oxide (WO₃), and cerium oxide (CeO₂).

Other than the foregoing compositions, the following compositions free from lead (Pb) can be contained: zinc oxide (ZnO) in 0-40 wt %; boron oxide (B₂O₃) in 0-35 wt %; silicon dioxide (SiO₂) in 0-15 wt %, and aluminum oxide (Al₂O₃) in 0-10 wt %.

The dielectric material containing the foregoing compositions is grinded by the wet jet mill or the ball mill into powder of which average particle diameter is 0.5 μm-2.5 μm. Next, this dielectric powder in 55-70 wt % and binder component in 30-45 wt % are mixed with a three-roll mill, so that the paste for the second dielectric layer to be used in the die-coating or the printing can be produced. The binder component is formed of terpinol or butyl carbitol acetate which contains ethyl-cellulose or acrylic resin in 1 wt %-20 wt %. The paste can contain, upon necessity, plasticizer such as dioctyl phthalate, dibutyl phthalate, triphenyl phosphate, tributyl phosphate, and dispersant such as glycerop mono-oleate, sorbitan sesquio-leate, alkyl-allyl based phosphate for improving the printing performance.

Then the paste of the second dielectric layer discussed above is applied onto first dielectric layer 81 with the die-coating method or the screen-printing method before the paste is dried. The paste is then fired at 550-590° C. a little bit higher than the softening point of the dielectric material.

The film thickness of dielectric layer 8 (total thickness of first layer 81 and second layer 82) is preferably not greater than 41 μm in order to secure the visible light transmission. First dielectric layer 81 contains a greater amount (20-40 wt %) of bismuth oxide (Bi₂O₃) than second dielectric layer 82 contains in order to suppress the reaction between metal bus electrodes 4b, 5b with silver (Ag), so that first layer 81 is obliged to have a visible light transmittance lower than that of second layer 82. To overcome this problem, first layer 81 is formed thinner than second layer 82.

If second dielectric layer 82 contains bismuth oxide (Bi₂O₃) not greater than 11 wt %, it resists to be colored; however, air bubbles tend to occur in second layer 82, so that the content of not greater than 11 wt % is not desirable. On the other hand, if the content exceeds 40 wt %, second layer 82 tends to be colored, so that it is not favorable for increasing the visible light transmittance.

A brightness of PDP advantageously increases and a discharge voltage also advantageously lowers at a thinner film thickness of dielectric layer 8, so that the film thickness is desirably set as thin as possible insofar as the dielectric voltage is not lowered. Considering these conditions, the film thickness of dielectric layer 8 is set not greater than 41 μm in this embodiment. To be more specific, first dielectric layer 81 has a thickness of 5-15 μm and second dielectric layer 82 has a thickness of 20-36 μm.

The PDP thus manufactured encounters little coloring (yellowing) in front glass substrate 3 although display electrodes 6 are formed of silver (Ag), and yet, its dielectric layer 8 has no air bubbles, so that dielectric layer 8 excellent in withstanding voltage performance is achievable.

The dielectric materials discussed above allows first dielectric layer 81 to have less yellowing or air bubbles. The reason is discussed hereinafter. It is known that the addition of molybdenum oxide (MoO₃) or tungstic oxide (WO₃) to the dielectric glass containing bismuth oxide (Bi₂O₃) tends to produce such chemical compounds at a temperature as low as 580° C. or lower than 580° C. as Ag₂MoO₄, Ag₂Mo₂O₇, Ag₂Mo₄O₁₃, Ag₂WO₄, Ag₂W₂O₇, Ag₂W₄O₁₃.

Since dielectric layer 8 is fired at a temperature between 550° C. and 590° C. in this embodiment, silver ions (Ag+) diffused in dielectric layer 8 during the firing react with molybdenum oxide (MoO₃), tungstic oxide (WO₃), cerium oxide (CeO₂), or manganese oxide (MnO₂) contained in dielectric layer 8, thereby producing a stable chemical compound. In other words, silver ions (Ag+) are stabilized without having undergone the reduction, so that the silver ions are not aggregated, nor form colloid. A smaller amount of oxygen is thus produced because the colloid formation accompanies the oxygen production. As a result, the smaller amount of air bubbles is produced in dielectric layer 8.

To use the foregoing advantage more effectively, it is preferable for the dielectric glass containing the bismuth oxide (Bi₂O₃) to contain molybdenum oxide (MoO₃), tungstic oxide (WO₃), cerium oxide (CeO₂), or manganese oxide (MnO₂) at a content not less than 0.1 wt %, and it is more preferable that the content should be in the range from not smaller than 0.1 wt % to not greater than 7 wt %. The content less than 0.1 wt % will reduce the yellowing in only little amount, and the content over 7 wt % will produce coloring to the glass, so that the content out of the foregoing range is unfavorable.

To be more specific, first dielectric layer 81 close to metal bus electrodes 4b, 5b made of Ag can reduce the yellowing and the air-bubbles, and second dielectric layer 82 placed on first dielectric layer 81 allows the light to transmit at a higher light transmittance. As a result, dielectric layer 8 as a whole allows the PDP to encounter both of the air bubbles and the yellowing in extremely smaller amounts, and yet, allows the PDP to have the higher light transmittance.

The material for primary dielectric layer 13 of rear panel 10 is formed of lead-free glass similar to the material for dielectric layer 8 of front panel 2; however, it is not necessary to apply such a severe condition to primary dielectric layer 13 as the foregoing condition applied to dielectric layer 8 of front panel 2 with respect to the coloring problem due to address electrodes 12 that contain silver.

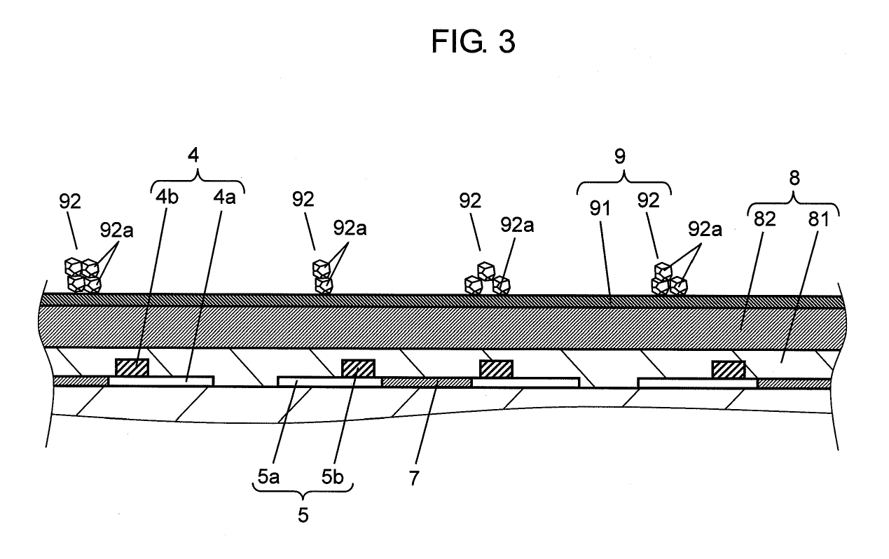

Protective layer 9 of the present invention is detailed about the structure and the manufacturing method hereinafter. FIG. 3 enlarges protective layer 9 of PDP 1 in accordance with this embodiment. As shown in FIG. 3, protective layer 9 is formed this way: primary film 91 made of MgO is formed on dielectric layer 8, and aggregated particles 92 are dispersed uniformly and discretely on the entire surface of this primary film 91. Aggregated particle 92 is formed by aggregating several crystal particles 92a made of metal oxide, i.e. MgO.

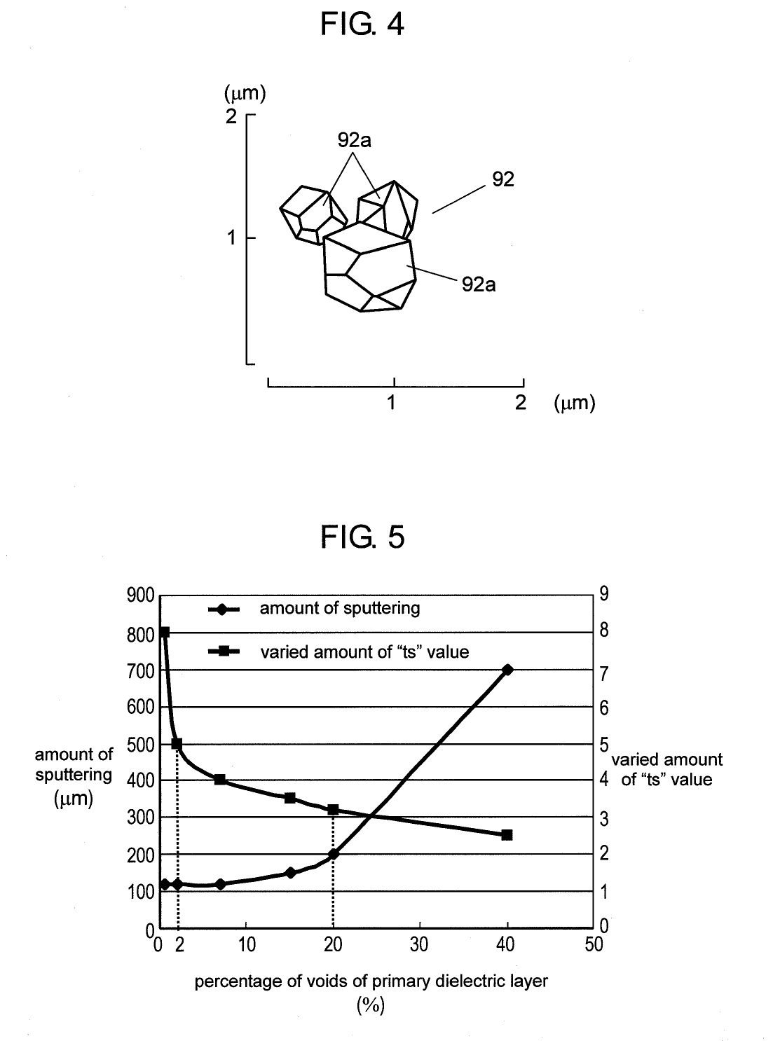

As shown in FIG. 4, aggregated particle 92 is formed by aggregating or necking crystal particles 92a, i.e. primary particles having a given size, and aggregated particles 92 is not bonded together like a solid body with great bonding force, but the multiple primary particles simply form an aggregate with static electricity or van der Waals force. Thus parts of or all of the aggregated particle 92 gather one another as weak as they turned into primary particles by external stimulus, such as an ultrasonic wave, thereby bonding together to form the aggregated particle 92. The particle diameter of aggregated particle 92 is approx. 1 μm, and crystal particle 92a desirably forms a polyhedral shape having seven faces or more than seven faces such as 14 faces or 12 faces.

The particle diameter of the primary particle, i.e. crystal particle 92a, can be controlled depending on a manufacturing condition of crystal particles 92a. For instance, when crystal particles 92a are formed by firing the precursor of MgO such as magnesium carbonate or magnesium hydroxide, the firing temperature or the firing atmosphere is controlled, whereby the particle diameter can be controlled. In general, the firing temperature can be selected from the range of 700-1500° C. A rather higher firing temperature over 1000° C. allows the diameter of the primary particle to fall within the range of 0.3-2 μm. Crystal particle 92a can be obtained by heating the precursor of MgO, and during its production steps, multiple primary particles are bonded by the phenomenon called necking or aggregated together, whereby aggregated particle 92 can be obtained.

As discussed above, protective layer 9 in accordance with this embodiment is constructed of primary film 91 made of MgO and formed on dielectric layer 8 and multiple aggregated particles 92, each of which is formed of several crystal particles aggregated together and made of metal oxide, attached over the entire face of primary film 91. This structure allows improving a discharge delay (ts) as one of the electron emission characteristics, and also improving the electric charge retention characteristics. As a result, the PDP having a greater number of scanning lines due to the high-definition specification and having cells in a smaller size can satisfy both of the electron emission capability and electric charge retention capability, so that the PDP with quality picture and driven at a lower voltage is obtainable.

On the other hand, the PDP, in which aggregated particles 92 made of MgO are formed on primary film 91 of the protective layer, has recently encountered problems of a rise in discharge voltage or flickering on video due to the discharge for a long time. The long-time discharge accelerates ion-impact to dig primary film 91 because the PDP has been used in an application of high definition with higher brightness recently popularized.

The dug amount of primary film 91 by sputtering depends on an amount of water existing in the discharge space, and it is known that the amount of sputtering increases at a greater amount of water. The water discharged from primary dielectric layer 13 of rear panel 10, in particular, to discharge space 16 influences greatly to the amount of sputtering. It is thus found that the percentage of voids of primary dielectric layer 13 should be controlled so that the transfer of the water from layer 13 to discharge space 16 and the diffusion of the water into active discharge space 16 can be controlled.

The embodiment of the present invention thus focuses on primary dielectric layer 13, and produces experimentally PDPs by varying the percentage of voids in primary dielectric layer 13. These PDPs are tested for the amount of sputtering after discharging each one of the PDPs in a given time and for the electron emission characteristics. The percentage of voids can be varied by adjusting the content of resin component contained in the paste before layer 13 is formed.

FIG. 5 shows a relation among the percentage of voids of primary dielectric layer 13, the electron emission characteristics, and the sputtering amount (dug depth by sputtering of film 91) to film 91 of the PDP. The horizontal axis represents the percentage of voids in dielectric layer 13, and the vertical axis represents the amount of sputtering and a varied amount of the discharge delay (ts value).

The percentage of voids is measured by processing the image of a sectional SEM photo of primary dielectric layer 13, and a sputtering amount to primary film 91 after the discharge in a given time is expressed in a dug depth measured on a sectional SEM photo of film 91. Before measuring the dug depth and the varied amount of discharge delay (ts value) in the initial discharge, the PDPs have undergone an accelerated life test corresponding to 20,000 hours.

The evaluation method disclosed in Unexamined Japanese Patent Application Publication No. 2007-48733 is employed to measure the discharge delay (ts value) as the electron emission characteristics, namely, a statistical delay time, which is a reference to the easiness of discharge occurrence, among delay times in discharge is measured. This reference number is inversed, and then integrated, thereby obtaining a value which linearly corresponds to the amount of emitted primary electrons, so that the value is used for the evaluation. The delay time in discharge expresses the time of discharge delay (hereinafter referred to as “ts” value) from the pulse rising.

As shown in FIG. 5, an amount of sputtering to primary film 91 and a varied amount of discharge delay largely depend on the percentage of voids of primary dielectric layer 13. To be more specific, The amount of sputtering increases at a greater percentage of voids, and it increases drastically when the percentage of voids exceeds 20%. This fact proves that an greater amount of water discharged from primary dielectric layer 13 accelerates the sputtering.

Variation in discharge delay (“ts” value), i.e. the discharge delay after the accelerated discharge corresponding to 20,000 hours, varies in a greater amount as the percentage of voids of primary dielectric layer 13 becomes smaller. Because if the percentage of voids becomes too small, the water discharged into the discharge space decreases, so that OH radical defect level existing on the of protective layer 9 cannot be steadily supplied. As a result, secondary electrons are discharged from the surface of protective layer 9 in a smaller amount, and the discharge thus delays.

In the case of a display device expecting 100,000 hours of service life, the acceleration life test having undergone the discharge for 20,000 hours requires the sputtering amount (dug depth of primary film 91 by sputtering) be not greater than 200 nm, and the varied amount of “ts” value be within 5 times. The service life of 100,000 hours thus can be ensured if the percentage of voids of primary dielectric layer 13 falls within a range from 2% to 20%.

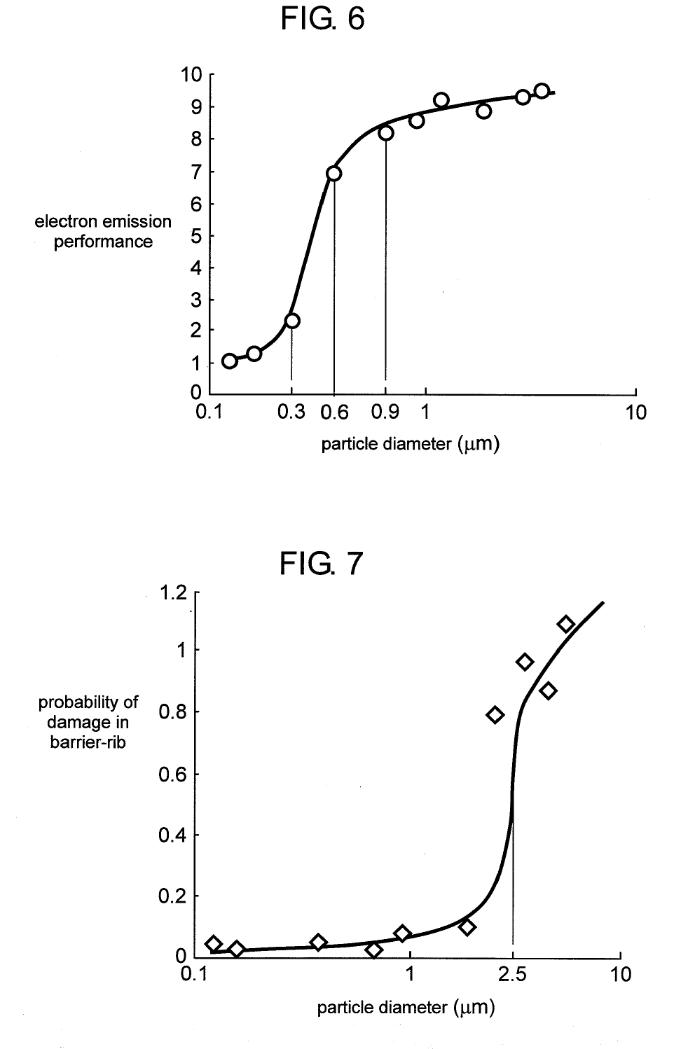

Next, a diameter of crystal particle 92a used in protective layer 9 of the PDP in accordance with this embodiment is described hereinafter. The diameter of particles refers to an average diameter, which means a cumulative volumetric average diameter (D50). FIG. 6 shows an experimental result of examining the electron emission performance by varying the particle diameter of crystal particle 92a of MgO forming aggregated particle 92. In FIGS. 6 and 7, the diameter of crystal particle 92a is measured by viewing the sectional SEM photo. The electron emission performance in FIG. 6 is described this way: measure the discharge delay as discussed previously, and a particle diameter of 0.1 μm is used as reference.

As shown in FIG. 6, the electron emission performance sharply lowers in a region where a diameter of crystal particle 92a falls under 0.6 μm (inclusive), and it can be kept in a high level in a region where the diameter falls over 0.9 μm (inclusive).

To increase the number of electrons discharged within a discharge cell, it is preferable that a larger number of crystal particles 92a exist at a unit area on protective layer 9. However, the experiment of the present invention proves this fact: Presence of crystal particles 92a at the top of barrier rib 14, with which protective layer 9 of front panel 2 closely contacts, damages the top of barrier rib 14, and then the material of rib 14 falls on phosphor layer 15, so that the cell encountering this problem cannot normally turn on or off. This damage of barrier rib resists occurring when crystal particle 92a does not exist at the top of barrier rib 14, so that a larger number of crystal particles 92a will increase the occurrence of damages in barrier ribs 14.

FIG. 7 shows an experimental result of dispersing crystal particles having different diameters in the same numbers at a unit area to find a relation between the diameter and the probability of the damages in the barrier ribs. The probability sharply increases when the diameter of crystal particle 92a grows as large as 2.5 μm; however, it stays at a rather low level when the diameter is not greater than 2.5 μm. The result tells that aggregated particle 92 preferably has particle diameter within a range from 0.9 μm to 2.5 μm. Considering a dispersion of crystal particles in manufacturing and a dispersion of protective layers in manufacturing, it is proved that use of the aggregated particles, of which average particle diameter falls within a range from 0.9 μm to 2 μm, allows obtaining steadily the advantages demonstrated in this embodiment.

As discussed above, the PDP in accordance with the embodiment of the present invention allows reducing the sputtering to the primary film, thereby achieving excellent electron emission performance as well as excellent electric charge retention performance. The long-life PDP having display performance of high definition with higher brightness, and consuming less power is thus obtainable.

In the foregoing discussion, the primary film made of chiefly MgO is used; however, it is not necessarily made of MgO, but other materials more excellent in shock resistance such as Al₂O₃ can replace MgO because the electron emission performance can be dominantly controlled by single crystal particles of metal oxide. In this embodiment, MgO particles are used as single crystal particles; however, other single crystal particles of metal oxide such as Sr, Ca, Ba, and Al as long as they have the electron emission performance as high as MgO can replace MgO. Use of these metal oxides can also achieve similar advantages to the foregoing ones. The single crystal particle is thus not limited to MgO.

### INDUSTRIAL APPLICABILITY

The PDP of the present invention has display performance of high definition with higher brightness, and yet, it has a long service life, so that the PDP is useful for a large size and high definition display device.

1. A plasma display panel (PDP) comprising:
a front panel including a substrate on which display electrodes are formed, a dielectric layer covering the display electrodes, and a protective layer formed on the dielectric layer; and
a rear panel opposing to the front panel to form a discharge space therebetween, and including address electrodes formed along a direction intersecting with the display electrodes, a primary dielectric layer covering the address electrodes, and barrier ribs formed on the primary dielectric layer for partitioning the discharge space,
wherein the protective layer includes a primary film made of metal oxide and formed on the dielectric layer, and an aggregated particle formed of several crystal particles aggregated together and made of metal oxide and attached to the primary film,
wherein a percentage of voids of the primary dielectric layer falls within a range from 2% to 20%.

2. The PDP of claim 1, wherein the metal oxide is magnesium oxide (MgO).

3. The PDP of claim 1, wherein the aggregated particle is formed of crystal particles of which average diameter falls within a range from 0.9 μm to 2 μm.

4. The PDP of claim 2, wherein the aggregated particle is formed of crystal particles of which average diameter falls within a range from 0.9 μm to 2 μm.
